(19) United States
(12) Patent Application Publication
(10) Pub. No.: US 2016/0269982 A1
(43) Pub. Date: Sep. 15, 2016

(54) RRC Diversity

(71) Applicant: Telefonaktiebolaget LM Ericsson (publ), Stockholm (SE)

(72) Inventors: Daniel Larsson, Stockholm (SE); Robert Baldemair, Solna (SE); Jung-Fu Cheng, Fremont, CA (US); Mats Folke, Vällingby (SE); Mattias Frenne, Uppsala (SE); Havish Koorapaty, Saratoga, CA (US)

(73) Assignee: Telefonaktiebolaget LM Ericsson (publ), Stockholm (SE)

(21) Appl. No.: 15/031,128

(22) PCT Filed: Oct. 25, 2013
(86) PCT No.: PCT/US2013/066775

§ 371 Date: Apr. 21, 2016

(51) Int. Cl. H04W 48/12; H04W 76/04; H04L 1/18; H04W 74/00; H04L 5/00

(52) U.S. Cl. CPC H04W 48/12; H04W 74/002; H04L 5/0048; H04L 1/1812; H04W 76/046

(57) ABSTRACT

The disclosure relates to enabling exchange of control messages between one user equipment 20 and multiple base stations 30a, 30b in a Long Term Evolution network. The present disclosure presents a method, performed in a first eNodeB 30a, wherein the first eNodeB defines a first cell 40a in a Long Term Evolution network, of enabling at least one second eNodeB 30b that defines a second cell 40b in a Long Term Evolution network, to exchange control messages with a user equipment 20 being connected to the first eNodeB. The method comprises the step of transmitting in the first cell, a first Channel State Information Reference Signal, CSI-RS. The method further comprises sending to the at least one second eNodeB, a request for the at least one second eNodeB to transmit a second Channel State Information Reference Signal, CSI-RS. Finally the method comprises sending, to the user equipment, a message configuring the user equipment with at least one enhanced physical downlink control channel set. The at least one enhanced physical downlink control channel, ePDCCH, set being associated with the first and the second Channel State Information Reference Signals. The disclosure relates both to methods of enabling exchange of control message performed in the first and second eNodeBs, as well as to base stations adapted thereto.

### TECHNICAL FIELD

The disclosure relates to enabling exchange of control messages between one user equipment and multiple base stations in a Long Term Evolution network. The disclosure relates to methods of enabling exchange of control message, as well as to base stations adapted thereto.

### BACKGROUND

3GPP Long Term Evolution, LTE, is the fourth-generation mobile communication technologies standard developed within the 3rd Generation Partnership Project, 3GPP, to improve the Universal Mobile Telecommunication System, UMTS, standard to cope with future requirements in terms of improved services such as higher data rates, improved efficiency, and lowered costs. The Evolved UTRAN, E-UTRAN, is the radio access network of an LTE system. In an E-UTRAN, a User Equipment, UE, is wirelessly connected to a Radio Base Station, RBS, commonly referred to as an evolved NodeB, or eNodeB. An RBS is a general term for a radio network node capable of transmitting radio signals to a UE and receiving signals transmitted by a UE.

The Radio Resource Control (RRC) protocol handles the control plane signalling of layer 3 between the UEs and the E-UTRAN. RRC includes e.g. functions for broadcast of system information and mobility procedures e.g. handover.

There can only be one RRC connection open to a UE at any one time. However, the messages of the connection may anyhow be transmitted via different base stations on lower layers. Therefore, introduction of RRC diversity has been discussed within the LTE releases 12 time frame. RRC diversity is a technique to enable the communication of RRC messages to a user equipment, UE, via anchor link and booster link. FIG. 1 shows the general idea for RRC diversity downlink signalling, i.e. that the message is signalled from both anchor eNodeB 30a and booster eNodeB 30b.

In RRC diversity, it is assumed that the RRC termination point on the network side lies in the anchor eNodeB. Thus to achieve RRC diversity, control messages are routed as duplicate Packet Data Convergence Protocol Packet Data Units, PDCP PDUs, via a backhaul link between anchor and booster eNodeBs. With this solution, on the UE side, duplicate PHY/MAC/RLC instances, separate Radio Access Channel procedures to obtain time synchronization and duplicate Cell Radio Network Temporary Identifiers, C-RNTIs, are required for each link. FIG. 1b shows the protocol stacks indicating the need for duplicate PHY/MAC/RLC instances in the UE according to the standardised solution for RRC diversity.

As improved mobility robustness is one of the major arguments for dual connectivity, RRC diversity is an especially interesting feature for the transmission of handover related messages such as UE measurement reports (MeasurementReport in [TS 36.331]) and RRC-reconfiguration requests (RRCConnectionReconfiguration including mobilityControlInfo in [TS 36.331] also known colloquially as “handover command”). Prior to a handover situation, the UE can be ordered to enter (and later leave) the RRC diversity-state based on legacy or new measurement reporting and new connection reconfiguration. Generally speaking, the connection to a UE may be regarded as lost if the link is considered out of sync, or if sufficient Signal to Interference and Noise Ratio (SINR) cannot be maintained leading to Radio Link Failure (RLF), or if the maximum RLC retransmission counters/timers are reached. Within this diversity mode, the connection to the UE is considered to be lost only if both links are considered lost.

The scheme is applicable both for same and separate frequency anchor and booster links. Four mobility scenarios benefiting from the RRC diversity scheme are shown in FIGS. 2a to 2d. Note that in these examples both Pico/Macro cells are assumed to be able to obtain either anchor or booster role.
1) FIG. 2a shows a handover between anchor 30a and booster 30b on same frequency. For the intra-frequency handover performance between Macro and Pico eNodeBs increased failure rates have been identified in a 3GPP Rel-11 study item [TR 36.839]. The problem is that a UE 20 entering a target cell while still connected to a source cell experiences RLF before it is able to receive the handover command from the source cell. With RRC diversity the handover command could additionally or solely be transmitted from the target cell 40b, for which the UE entering the coverage area of this cell will naturally have a better SINR. This will eventually lead to a more successful network-controlled handover performance (i.e. UE RRC re-establishment procedure and inherent delays are avoided).
2) FIG. 2b shows handover between anchor 30a and booster 30b on separate frequencies. For load balancing purposes e.g. between a Macro-layer and Pico-layer on different frequencies, it is beneficial to trigger handovers to the Pico layer as early as possible and back to the Macro layer as late as possible in order to maximize the offloading potential. Avoidance of radio link failures has the opposite requirement. RRC diversity would allow us in this situation to avoid RLF while at the same time improve the offloading to the Pico layer.
3) FIG. 2c shows handover between boosters 30b on same frequency assisted by anchor 30a on separate frequency. To improve the intra-frequency mobility robustness, e.g. in a very densely deployed booster-layer, RRC diversity can be established between at least one of these booster and an overlaying anchor 30a operating on a different frequency. A handover command can then e.g. be transmitted via anchor link, which is not interfered by any of the booster cells.
4) FIG. 2d shows handover between anchors 30a on same frequency assisted by booster 30b on separate frequency. In a similar way as described above, handover robustness between two anchor eNodeBs can be improved by adding RRC diversity from a booster eNodeB on separate frequency, deployed on the cell border between the anchors.

This description of RRC diversity should only be seen as an introduction to RRC diversity and if RRC diversity is implemented it may not look exactly like this. For example, if RRC diversity is defined it may be so that the UE does not monitor each link separately for example for RLF purpose but instead monitors one of the links. Common for the above described RRC diversity solutions, is that the user plane and control plane architectures have to be defined to support it. However, there is a need for RRC diversity, also for terminals only supporting legacy LTE releases that do not have this support.

As an example, in legacy LTE releases, the handover command, which is one example of a control message, is only sent from the serving cell, i.e. the cell from which the UE is leaving, to the UE. In most cases the radio channel towards the target cell is better than the radio channel towards the serving cell, and it is therefore important to send the handover command before the radio channel towards the source cell has deteriorated below the point of successful reception. In certain network deployments, such as heterogeneous network deployments with small cells, or in high-speed scenarios this problem is aggravated such that the existing solutions are not able to successfully send the handover command in time to the UE. Furthermore, there are other RRC messages that would also benefit from RRC diversity.

Hence, the above-discussed RRC diversity requires new UEs conforming with the upcoming LTE releases to operate and is not applicable to UEs only conforming with earlier LTE specifications. Therefore a way to enable RRC diversity for legacy UEs is highly sought for.

### SUMMARY

The proposed technique proposes methods of providing dual connectivity towards user equipments without the need for any standard changes compared to the Rel-11 version of LTE. The proposed method enables a UE to be connected to separate eNodeBs that are connected with any backhaul and are transmitting on the same frequency. This is solved using a combination of functions like ePDCCH and quasi collocation, which both exist in Rel-11. The solution is transparent to the UE and does not require any standard changes compared to LTE Rel-11.

The present disclosure presents a method, performed in a first eNodeB, wherein the first eNodeB defines a first cell in a Long Term Evolution network, of enabling at least one second eNodeB that defines a second cell in a Long Term Evolution network, to exchange control messages with a user equipment being connected to the first eNodeB. The method comprises the step of transmitting in the first cell, a first Channel State Information Reference Signal, CSI-RS. The method further comprises sending to the at least one second eNodeB, a request for the at least one second eNodeB to transmit a second Channel State Information Reference Signal, CSI-RS. Finally the method comprises sending, to the user equipment, a message configuring the user equipment with at least one enhanced physical downlink control channel set. The at least one enhanced physical downlink control channel, ePDCCH, set being associated with the first and the second Channel State Information Reference Signals. The benefit is that the UE can then exchange control messages with the second eNodeB as well, because the UE is configured with an ePDCCH set that is associated with a CSI-RS transmitted from the second eNodeB. The benefit is more robust mobility handling, because control messages may be transmitted from two eNodeBs.

According to one aspect the message is configuring the user equipment with a first enhanced physical downlink control channel, ePDCCH, set associated with the first CSI-RS and a second enhanced physical downlink control channel ePDCCH, set associated with the second CSI-RS. By configuring two separate ePDCCH associated with different eNodeBs, the UE may be scheduled from two different eNodeBs.

According to another aspect the first CSI-RS and the second CSI-RS have the same configuration and wherein the user equipment is configured with one ePDCCH set associated with the first and the second Channel State Information Reference Signals. By configuring one ePDCCH associated with two eNodeBs, the UE may be scheduled from two different eNodeBs simultaneously. The messages will then combine over the air, which increases the chance of successful reception.

According to one aspect, the method further comprises receiving, from the user equipment, a report on worsened radio conditions. Hence, RRC diversity may only be activated when needed.

According to one aspect, the method further comprises sharing with the second eNodeB, information about control messages to be exchanged with the user equipment. In principle, the disclosure requires that multiple eNodeBs cooperate with each other, which is beneficial in a network which is operated by a single network vendor.

According to one aspect, the method further comprises scheduling, on the at least one enhanced physical downlink control channel set configured in the user equipment, transmissions of control messages to and/or from the user equipment. The shared control messages may be scheduled and transmitted from the first eNodeB, from the second eNodeB or from both. This provides flexibility.

According to one aspect the disclosure relates to a method, performed in a second eNodeB, defining a second cell, of enabling exchange of control messages with a user equipment being connected to a first eNodeB defining a first cell. The method comprises receiving from the first eNodeB, a request for the second eNodeB, to transmit a second Channel State Information Reference Signal, CSI-RS, and transmitting the second CSI-RS. This corresponds to the actions performed in the second eNodeB, when receiving a request from a first eNodeB.

According to one aspect, an enhanced physical downlink control channel, ePDCCH, set configured in the user equipment is associated with the CSI-RS that the second eNodeB is requested to transmit.

According to one aspect, the method further comprises sharing with the first eNodeB, information about control messages to be exchanged with the user equipment.

According to one aspect, the method further comprises scheduling, on a ePDCCH set associated with the second CSI-RS, transmissions of control messages to and/or from the user equipment.

According to one aspect, the method further comprises transmitting, control messages to and/or from the user equipment.

According to one aspect the present disclosure relates to a first eNode defining a first cell in the Long Term Evolution network, configured for of enabling at least one second eNodeB defining a second cell in the Long Term Evolution network, to exchange control messages with a user equipment being connected to the first eNodeB. The first eNodeB comprises a communication unit and processing circuitry. The processing circuitry is adapted to transmit, using the communication unit, in the first cell, a first Channel State Information Reference Signal, CSI-RS. The processing circuitry is further adapted to send, using the communication unit, to the at least one second eNodeB, a request for the at least one second eNodeB to transmit a second Channel State Information Reference Signal, CSI-RS and send, using the communication unit, to the user equipment, a message configuring the user equipment with at least one enhanced physical downlink control channel set; the at least one enhanced physical downlink control channel set being associated with the first and the second Channel State Information Reference Signals.

According to one aspect the present disclosure relates to a second eNode, defining a second cell in the Long Term Evolution network, configured for enabling exchanging control messages with a user equipment being connected to a first eNodeB defining a first cell in the Long Term Evolution network. The second eNodeB comprises a communication unit and processing circuitry. The processing circuitry are adapted to receive, using the communication unit, from the first eNodeB, a request for the second eNodeB, to transmit a second Channel State Information Reference Signal, CSI-RS, and transmit, using the communication unit, the second CSI-RS.

According to one aspect the present disclosure relates to computer program, comprising computer readable code which, when run in a eNodeB, causes the eNodeB to perform the methods described above.

With the above description in mind, the object of the present disclosure is to overcome at least some of the disadvantages of known technology as described above and below.

### BRIEF DESCRIPTION OF THE DRAWINGS

FIG. 1a show the general idea for RRC diversity, i.e. that the message is signaled from both anchor and booster.

FIG. 1b shows RRC protocol termination, i.e. the protocol stacks indicating the need for duplicate PHY/MAC/RLC instances in the UE.

FIG. 2a-d illustrates different mobility scenarios that would be benefiting from RRC diversity.

FIG. 2a shows handover between anchor and booster on same frequency.

FIG. 2b shows handover between anchor and booster on separate frequencies.

FIG. 2c shows handover between boosters on same frequency assisted by anchor on separate frequency.

FIG. 2d shows handover between anchors on same frequency assisted by booster on separate frequency.

FIG. 3a illustrates the LTE downlink physical resource configuration.

FIG. 3b illustrates the LTE time-domain structure.

FIG. 3c illustrates the configuration of three Enhanced Physical Downlink Control Channel regions a LTE Downlink sub frame.

FIG. 4a illustrates a downlink subframe wherein Enhanced Physical Downlink Control Channel is split into four parts, which are mapped to several control regions.

FIG. 4b illustrates a downlink sub frame wherein the four parts belonging to an Enhanced Physical Downlink Control Channel is mapped to one of the control regions.

FIG. 4c illustrates examples of user equipment specific reference symbols in LTE.

FIG. 5 is a flowchart illustrating embodiments of method steps executed in a main serving eNodeB according to one aspect of the disclosure.

FIG. 6 is a flowchart illustrating embodiments of method steps executed in a serving eNodeB according to one aspect of the disclosure.

FIG. 7 is a signalling diagram illustrating an exchange of signals between a main serving eNodeB and a serving eNode B according to one exemplary embodiment.

FIG. 8a is a block diagrams illustrating an embodiment of a main serving eNodeB.

FIG. 8b is a block diagrams illustrating an embodiment of a serving eNodeB.

### DETAILED DESCRIPTION

The RRC diversity solutions discussed in the background section requires new UEs conforming with the upcoming LTE releases to operate and is not applicable to UEs only conforming with earlier LTE specifications. The reason is that the UE needs to be able to connect to multiple cells, wherein the cells cannot be operated in either DL CoMP mode or CA. In practice this means that the cells are not directly connected with very low-latency backhaul (e.g. Common Public Radio Interface) and do not share a common processing (i.e. processing is not done in the same RBS). On top of this the procedures for operating RRC diversity is not defined within earlier LTE specification, as for example how to handle the duplicate PHY/MAC/RLC instances, a separate RACH procedure to obtain time synchronization and C-RNTI for each link.

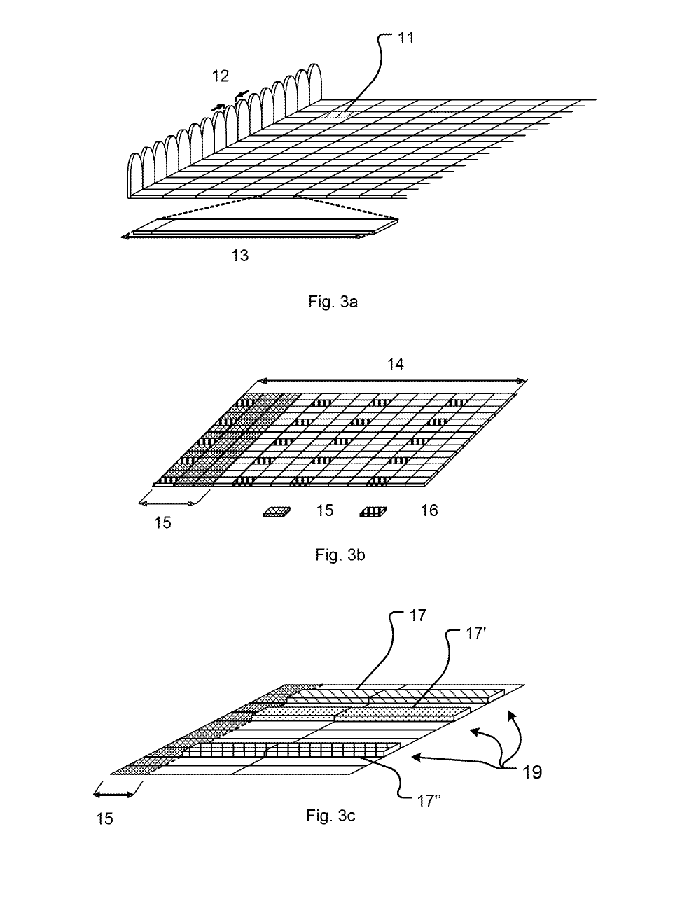

This disclosure proposes a method that enables a legacy user equipment complying with LTE release 11 whose user plan and control plan architecture do not support RRC diversity, to be connected to separate eNodeBs that are connected with any backhaul and are transmitting on the same frequency. The method is based on a combination of functions like ePDCCH and QCL which both exist in LTE Rel-11. The solution is transparent to the user equipment and does not require any standard changes compared to LTE Rel-11. The benefit with the disclosure is that it provides more robust mobility handling, because messages may be exchanged with different eNodeBs. In addition the disclosure requires that multiple eNodeBs cooperate with each other, which is beneficial in a network which is operated by a single network vendor. LTE uses Orthogonal Frequency Division Multiplexing, OFDM, in the downlink and DFT-spread OFDM (a.k.a. SC-FDMA) in the uplink. The basic LTE downlink physical resource can thus be seen as a time-frequency grid as illustrated in FIG. 3a, where each resource element 11 corresponds to one OFDM subcarrier 12 during one OFDM symbol interval 13. Furthermore, the resource allocation in LTE is typically described in terms of resource blocks, RB, where a resource block corresponds to one slot (0.5 ms) in the time domain and 12 contiguous subcarriers in the frequency domain. A pair of two adjacent resource blocks in time direction (1.0 ms) is known as a resource block pair. Resource blocks are numbered in the frequency domain, starting with 0 from one end of the system bandwidth.

The notion of virtual resource blocks, VRB, and physical resource blocks, PRB, has been introduced in LTE. The actual resource allocation to a UE is made in terms of VRB pairs. There are two types of resource allocations, localized and distributed. In the localized resource allocation, a VRB pair is directly mapped to a PRB pair, hence two consecutive and localized VRB are also placed as consecutive PRBs in the frequency domain. On the other hand, the distributed VRBs are not mapped to consecutive PRBs in the frequency domain thereby providing frequency diversity for data channel transmitted using these distributed VRBs.

In LTE, downlink transmissions are dynamically scheduled, i.e. in each subframe 13 an eNodeB transmits control information about to which terminals data is transmitted and upon which resource blocks the data is transmitted, in the current downlink subframe. Control signalling 15 in LTE is illustrated in FIG. 3b.

This control signalling 15 is typically transmitted in the first 1, 2, 3 or 4 OFDM symbols in each subframe and the number n=1, 2, 3 or 4 is known as the Control Format Indicator, CFI. The downlink subframe also contains common reference symbols (CRS) 16, which are known to the receiver and used for coherent demodulation of e.g. the control information. In FIG. 3b, CFI=3 OFDM symbols.

In LTE release 8, the first one to four OFDM symbols 15, in a sub frame, are reserved to contain control information, see FIG. 3b. Furthermore, in Rel-11, an Enhanced Physical Downlink Control Channel, ePDCCH, was introduced in which PRB pairs are reserved to exclusively contain ePDCCH transmissions, although excluding from the PRB pair the one to four first symbols 15 that may contain control information to UEs. FIG. 3c illustrates a Downlink subframe showing 10 PRB pairs 19 and configuration of three ePDCCH regions, 17, 17′, 17″, of size 1 PRB pair each. The remaining PRB pairs can be used for Physical Downlink Shared CHannel, PDSCH, transmissions. Hence, the ePDCCH is frequency multiplexed with PDSCH transmissions contrary to PDCCH which is time multiplexed with PDSCH transmissions. Furthermore, two modes of ePDCCH transmission are supported, the localized and the distributed ePDCCH transmission.

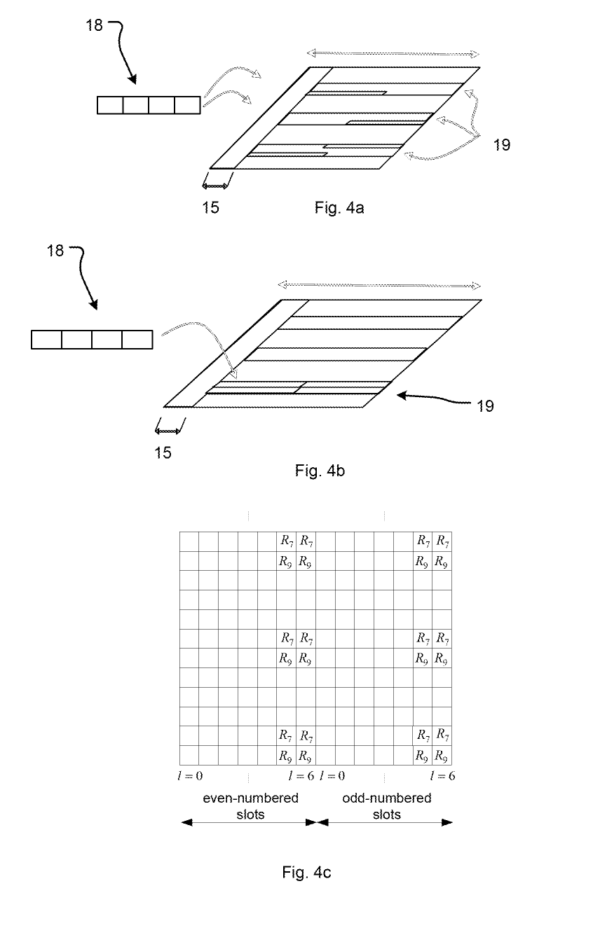

In distributed transmission, an ePDCCH 17 is mapped to resource elements in up to N PRB pairs, where N=2, 4, or 8. These are denoted an ePDCCH set 18. In this way frequency diversity can be achieved for the ePDCCH message. FIG. 4a shows a Downlink subframe, as the one illustrated in FIG. 3c, showing a split of an ePDCCH set 18 into 4 parts or Enhanced control channel element, ECCE, mapped to multiple of the enhanced control regions known as PRB pairs 19, to achieve distributed transmission and frequency diversity.

In localized transmission, an ePDCCH set 18 is mapped to one PRB pair only for aggregation level 1, 2 and 4 (see below for discussion on aggregation levels). In case the aggregation level of the ePDCCH is too large, a second PRB pair is used as well, and so on, using more PRB pairs, until all ECCE belonging to the ePDCCH set 18 has been mapped. See FIG. 4b for an illustration of localized transmission. FIG. 4b illustrates a Downlink subframe showing the 4 parts belonging to an ePDCCH is mapped to one of the enhanced control regions 19, to achieve localized transmission.

To facilitate the mapping of ECCEs to physical resources each PRB pair is divided into 16 enhanced resource element groups, eREGs, and each ECCE is split into L=4 or L=8 eREGs for normal and extended cyclic prefix, respectively. An ePDCCH is consequently mapped to a multiple of four or eight eREGs depending on the aggregation level.

The ePDCCH is using a Demodulation Reference Signal, DMRS, for demodulation, where antenna ports 107-110 have been defined for this purpose. These antenna ports are the same as port 7-10 used for PDSCH demodulating apart from an independent DMRS scrambling sequence initialization. FIG. 4c shows these UE specific DMRS for PDSCH in a normal subframe with normal Cyclic Prefix, CP. In localized transmission in normal CP case, all four antenna ports are available and the ePDCCH use one of these in the PRB pair. In distributed transmission, two of the four antenna ports are used for ePDCCH demodulation in the PRB pair, as to achieve spatial (antenna) diversity of the ePDCCH message. In normal CP, port 107+109 is used (corresponding to AP7+9 for PDSCH) and in extended CP, port 107+108 is used. The DMRS sequence is configured by RRC to the UE and independently per ePDCCH set. Furthermore, the same parameter that configures the DMRS sequence for an ePDCCH set is used also to configured the scrambling sequence for the DCI message transmitted in the corresponding ePDCCH set.

The network typically configures the UE to assist in the reception of various signals and/or channels based on different types of reference signals, RS, including, e.g., CRS, DMRS, CSI-RS. Possibly, RS may be exploited for estimation of propagation parameters and preferred transmission properties to be reported by the UEs to the network, e.g., for link adaptation and scheduling.

Even though in general the channel from each antenna port to each UE receive port is substantially unique, some statistical properties and propagation parameters may be common or similar among different antenna ports, depending on whether the different antenna ports originate from the same point or not. Such properties include, e.g. the received power level for each port, the delay spread, the Doppler spread, the received timing (i.e., the timing of the first significant channel tap) and the frequency shift.

Typically, channel estimation algorithms perform a three step operation. A first step consists of the estimation of some of the statistical properties of the channel. A second step consists of generating an estimation filter based on such parameters. A third step consists of applying the estimation filter to the received signal in order to obtain channel estimates. The filter may be equivalently applied in the time or frequency domain. Some channel estimator implementations may not be based on the three steps method described above, but still exploit the same principles.

Obviously, accurate estimation of the filter parameters in the first step leads to improved channel estimation. Even though it is often in principle possible for the UE to obtain such filter parameters from observation of the channel over a single subframe and for one RS port, it is usually possible for the UE to improve the filter parameters estimation accuracy by combining measurements associated with different antenna ports (i.e., different RS transmissions) sharing similar statistical properties

Geographical separation of RS ports implies that instantaneous channel coefficients from each antenna port towards the UE are in general different. Furthermore, even the statistical properties of the channels for different ports and RS types may be significantly different.

Based on the above observations, the UE needs to perform independent estimation for each RS port of interest for each RS. This results in occasionally inadequate channel estimation quality for certain RS ports, leading to undesirable link and system performance degradation.

Hence, in transmission mode 10 (TM10), the concept of quasi co-location (QCL) between antenna ports is introduced in Rel.11. It means that some of the statistical properties of the channel corresponding to a DMRS antenna port can be assumed to be the same as the properties of another RS, such as an assigned Channel State Information, CSI-RS, antenna port. Hence, the UE can use the CSI-RS, which is wideband and periodic, to estimate channel statistics, which it subsequently can use to tune the DMRS channel estimation filter, to receive DMRS based PDSCH transmission or ePDCCH transmissions.

Therefore, up to four different CSI-RS resources can be configured to be QCL with the PDSCH transmission in transmission mode 10 using the RRC parameter qcI-CSI-RS-ConfigNZPId [3]. Which one of the four CSI-RS resources the UE shall assume when demodulating the PDSCH is indicated in the ePDCCH message by two dedicated signalling bits in DCI format 2D. It is thus possible to have four different transmission hypotheses, e.g. four different eNodeB, or combination of transmissions from several eNodeB and dynamically switch between them by fast layer 1 control signalling. This is very useful for DL CoMP operation. According to the proposed technique, the possibility to have different transmission hypotheses is utilised in order to enable RRC diversity.

Moreover, when configured in TM10 and when also configured to monitor ePDCCH, the UE can further be configured by RRC to associate each ePDCCH set with one of the CSI-RS resources configured by RRC using qcI-CSI-RS-ConfigNZPId for the PDSCH reception. Hence two of the PDSCH transmission hypotheses with respect to statistical properties can be reused for each of the two ePDCCH sets respectively. Thereby DL CoMP is also possible for ePDCCH in TM10.

Note that the Rel.11 standard flexibility allows the ePDCCH to be transmitted from a first eNodeB and the ePDCCH contains a scheduling message indicating a PDSCH that is transmitted from a second eNodeB. Hence, the CSI-RS that is QCL with the DMRS used for ePDCCH reception and PDSCH reception in the same subframe may be different as in this case.

The proposed method is based on the assumption that the received signals at the UE from the multiple eNodeBs are time synchronized within the cyclic prefix and frequency synchronized enough for communication of at least low data rate signals. This sets some constraints on the network operations as well, but does not strictly mean that the network needs to be perfectly synchronized, although the best performance is achieved with better synchronization.

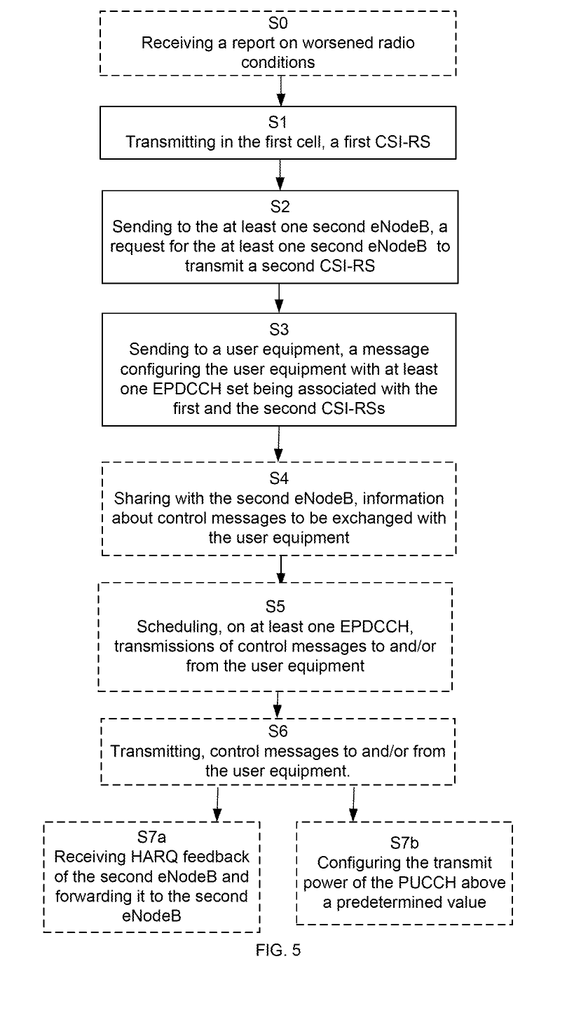

In the following text the first eNodeB 30a can be referred to as the main serving eNodeB corresponding to the anchor link and the second eNodeB a serving eNodeB, i.e. the booster link. It is further possible to extend the example to include more than two cells as well. In a generalization of the above, the first eNodeB 30a and the second eNodeB 30b can actually correspond to transmission points with the same cell ID (PCI) or with different PCI. The method steps executed in a main serving eNodeB according to one aspect of the proposed technique will now be further described referring to FIG. 5.

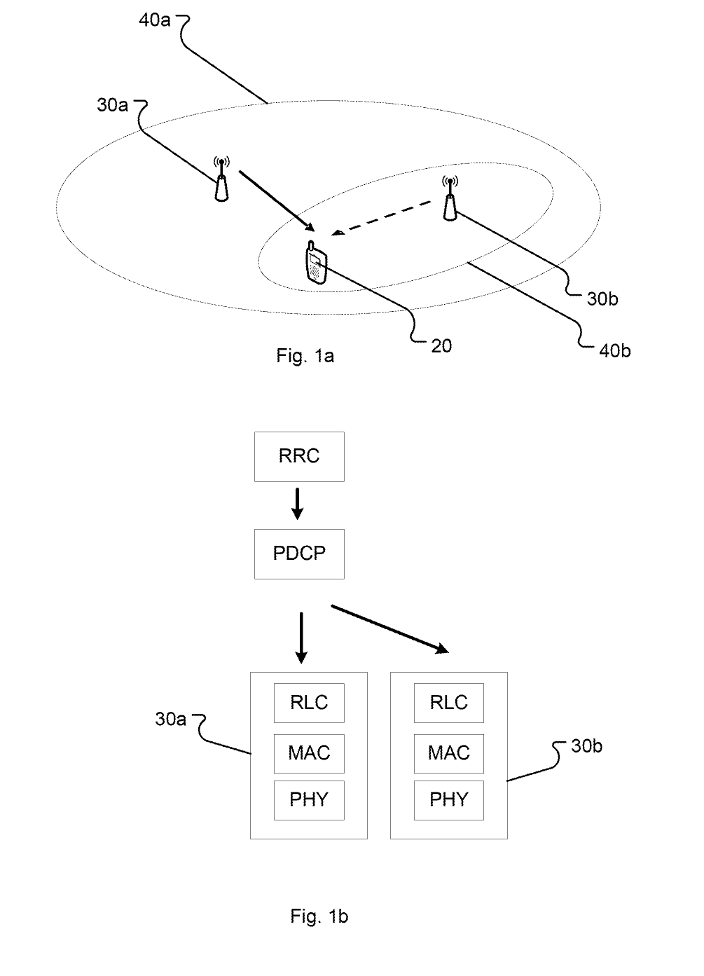

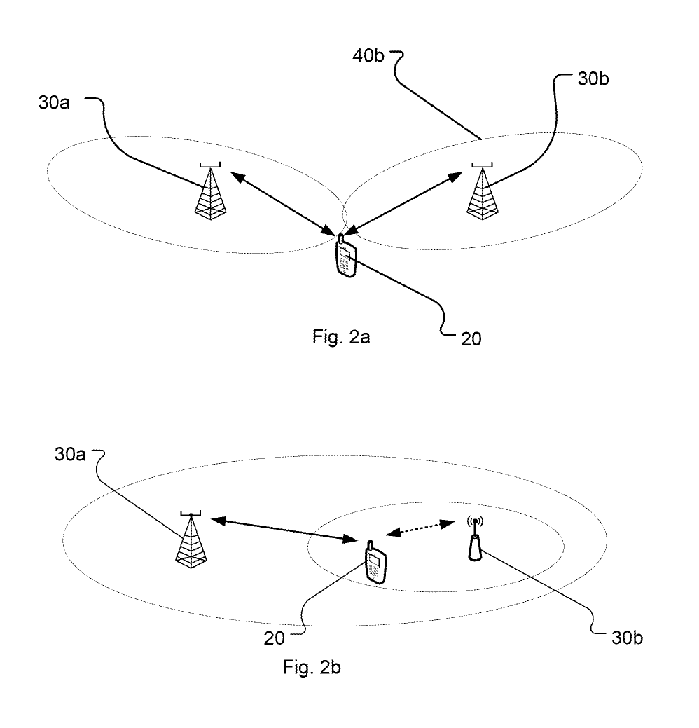

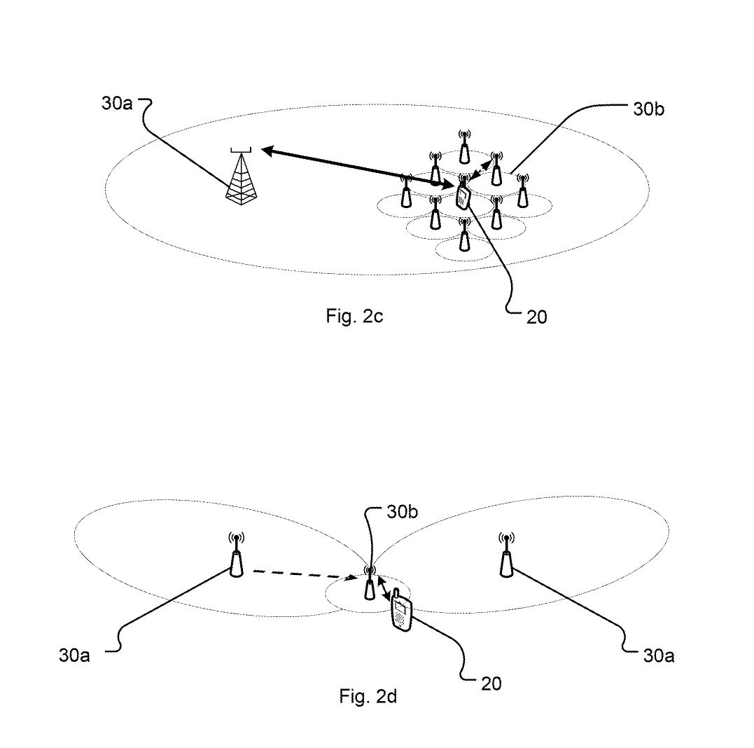

FIG. 5 discloses a method, performed in a first eNodeB 30a, the first eNodeB 30a defining a first cell 40a in a Long Term Evolution network, of enabling at least one second eNodeB 30b, the second eNodeB 30b, defining a second cell 40b in the Long Term Evolution network, to exchange control messages with a user equipment 20 being connected to the first eNodeB 30a. The first eNodeB is e.g. the eNodeBs 30a in one of the FIG. 1 or 2. The configuration of two CSI-RS resources corresponding to two eNodeBs enables the network to track the SINR of the respective channel. This is transparent to the UE, as the UE makes no assumption on the number of eNodeBs transmitting on each CSI-RS resource.

The method is e.g. executed when the channel conditions between a first eNodeB 30a and a user equipment 20 is worsened. According to one aspect the first eNodeB 30a then receives S0, from the user equipment, a report on worsened radio conditions. For example the user equipment reports Reference Signal Receive Power, RSRP, Reference Signal ReceiveQuality, RSRQ, UE position, Power Headroom report, PHR, or Channel State information, CSI. The report could either be a direct report of the applicable value or a relative value. For example the RSRP could be report relative compared to the serving cell. The first eNode B 30a can, based on the report, decide to enable RRC diversity. The network can choose to configure the UE with a second ePDCCH set with an associated second CSI-RS corresponding to a second eNodeB only if this is deemed necessary by the network. Configuring the UE with a secondary ePDCCH set will limit the possibility to schedule the UE from the main eNodeB since the number of blind decodes on EPDCCH/PDCCH of the main eNodeB is reduced.

According to the proposed technique, RRC diversity is enabled by executing the following steps. In the first step, the first eNodeB 30a transmits S1 in the first cell 40a, a first Channel State Information Reference Signal, CSI-RS. This first CSI-RS is typically a CSI-RS already configured in the cell. Hence, in principle step S1 may be executed before the decision to enable RRC diversity is taken.

The first eNodeB 30a then sends S2 to the at least one second eNodeB 30b, a request for the at least one second eNodeB 30b to transmit a second Channel State Information Reference Signal, CSI-RS. Another example is that the second CSI-RS may already be transmitted by the second eNB before the UE see worsen radio conditions. In some aspects of the method, the same transmission hypothesis is used for the first and the second CSI-RS transmitted from the first and the second eNodeB. In this case the signals are combining over the air and will be seen as one signal, from the UE. According to another aspect, the transmission hypotheses are different. The UE will then receive the signals as if they were transmitted from different transmitters, which they are. Examples will follow to explain this further.

In the next step the first eNodeB 30a sends S3, to the user equipment 20, a message configuring the user equipment with at least one enhanced physical downlink control channel set; the at least one enhanced physical downlink control channel set being associated with the first and the second Channel State Information Reference Signals. Hence, in order for the UE to operate in the transparent RRC diversity mode the UE is configured by its serving eNodeB, i.e. the first eNodeB 30a, with one CSI-RS associated with the first eNodeB 30a and one CSI-RS resource associated with a second eNodeB 30b. Furthermore, the UE is typically configured with a single C-RNTI according to Rel.11 configuration. According to one aspect, the method of enabling exchange of control messages further comprises the sharing the user equipment's C-RNTI, assigned in the first eNodeB 30a with the second eNodeB 30b.

The UE can thus receive control messages from two different eNodeBs. However, the UE will not know that it is two different eNodeBs, but will only assume different transmitters.

The UE is now configured with at least one enhanced physical downlink control channel set, which is mapped to two CSI-RS sets transmitted from a first and a second eNodeBs. This means that depending on the configuration control messages may be scheduled from either the first or the second eNodeB, or alternatively in from both eNodeBs simultaneously.

According to one aspect the message is configuring the user equipment with a first enhanced physical downlink control channel, ePDCCH, set associated with the first CSI-RS and a second enhanced physical downlink control channel ePDCCH, set associated with the second CSI-RS. In other words, by performing the method, the UE is configured in transmission mode 10 [1] and with two ePDCCH sets where each set is associated with a CSI-RS resource through the identity of a RRC configured qcI-CSI-RS-ConfigNZPId by the RRC specification parameter re-MappingQCL-ConfigListId, see 3GPP TS 36.331. This setup implies that the first eNodeB can use the first ePDCCH to schedule control messages to the UE and the second eNodeB can use the second ePDCCH to schedule control messages to the UE.

The User Equipment (UE) is required to perform blind decoding of the ePDCCH, according to detailed configured control channel structure, including the number of control channels and the number of control channel elements, CCEs, to which each control channel is mapped. The blind decodes per ePDCCH set maybe allocated differently for the different ePDCCH sets. For example if the UE is primarily scheduled from one of the eNodeBs the ePDCCH set associated with this eNodeB could be allocated a larger share of blind decodes than the other eNodeBs to allow for greater scheduling flexibility. This is feasible, as the total blind decodes is divided among all the ePDCCH sets the UE is configured with and can be controlled by the number N of PRB pairs per ePDCCH set and whether the set is of localized or distributed type. For instance, a set with N=8 PRB pairs is given a larger share of the total number of blind decodes than a set with N=2 PRB pairs.

According to another aspect, the first CSI-RS and the second CSI-RS have the same resource configuration and wherein the user equipment is configured with one ePDCCH set associated with the first and the second Channel State Information Reference Signals. Then the UE will see the transmissions as one signal, because the signals will combine over the air. In this way it is possible to transmit the same message from both eNodeBs in order to increase the likelihood for successful transmissions.

The UE is now set up to receive control messages from two eNodeBs. However, as mentioned above RRC is terminated in the eNodeB. Therefore, according to another aspect, the method further comprises sharing S4 with the second eNodeB 30b, information about control messages to be exchanged with the user equipment 20. This step implies e.g. that when a control message is scheduled from the first eNodeB 30a, information about the message is sent to the second eNodeB so that it may perform a simultaneous transmission from the second eNodeB.

RRC control messages such as handover commands and measurement reports are typically transmitted on the Physical Downlink Shared Channel, PDSCH. According to another aspect, the method further comprises scheduling S5, on the at least one enhanced physical downlink control channel set configured in the user equipment 20, transmissions of control messages to and/or from the user equipment. Hence, the ePDCCH associated with the second eNodeB 30b is used in order to schedule PDSCH resources to the UE 20.

However, scheduling and control message are not necessarily transmitted from the same eNodeB. According to another aspect, the method further comprises, scheduling S5 control messages. According to another aspect the step of scheduling S5 control messages comprises scheduling control messages for transmission to and/or from the second eNodeB 30a. Hence, the first eNodeB 30a may schedule messages to be transmitted from another eNodeB. One possibility is that scheduling is done for both the first and second eNB but at different times.

According to another aspect the step of scheduling S5 control messages comprises scheduling control messages for transmission to and/or from the first eNodeB 30a. Hence, the control messages may be scheduled and transmitted from the same eNodeB. This will be explained further in the examples below.

According to another aspect, the method further comprises, transmitting S6, control messages to and/or from the user equipment. In this final step, the actual control message is transmitted from the first eNodeB. In some variants, the control message is instead transmitted from the second eNodeB.

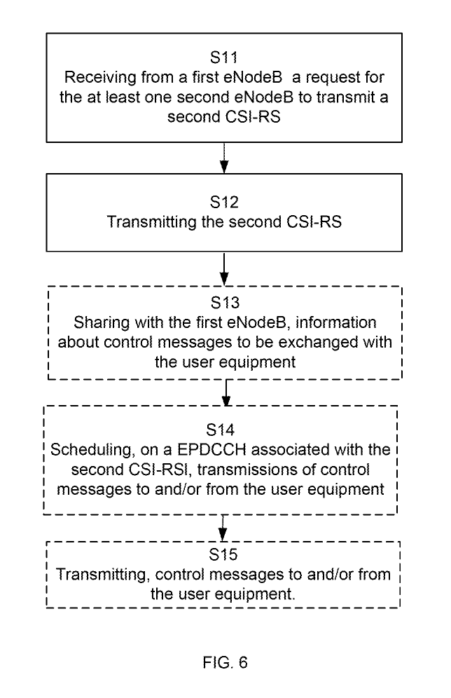

The method steps executed in a serving eNodeB, here the second eNodeB 30b, according to one aspect of the disclosure will now be further described referring to FIG. 6. FIG. 6 discloses a method, performed in a second eNodeB 30b, defining a second cell 40b, of enabling exchange of control messages with a user equipment 20 being connected to a first eNodeB 30a defining a first cell 40a. The method is executed when a first main serving eNodeB enables RRC diversity.

In the first step, the second eNodeB receives S11 from the first eNodeB 30a, a request for the second eNodeB 30b, to transmit a second Channel State Information Reference Signal, CSI-RS. In the next step the second eNodeB transmits S12 the second CSI-RS.

According to one aspect an enhanced physical downlink control channel, ePDCCH, set configured in the user equipment 20 is associated with the CSI-RS that the second eNodeB 30b is requested to transmit. Thereby, the UE 20 is configured with a ePDCCH set associated with the second eNodeB 30b.

According to one aspect the method further comprises sharing with the first eNodeB 30a, information about control messages to be exchanged with the user equipment 20.

According to one aspect the method further comprises further comprises scheduling, on the ePDCCH set associated with the second CSI-RS, transmissions of control messages to and/or from the user equipment 20.

According to one aspect the method the step of scheduling transmissions of control messages comprises scheduling simultaneous transmission by the second eNodeB 30b of a control message to be transmitted in the first eNodeB 30. According to one aspect the method further comprises transmitting, from the second eNodeB 30b, control messages to and/or from the user equipment 20. Alternatively the second eNodeB 30b may schedule messages to be transmitted by other nodes.

Below follow some examples of how the RRC diversity may be used for scheduling control messages from different eNodeBs, once enables using the methods proposed in FIGS. 5 and 6. In this disclosure the UE is connected to several eNodeBs. Based on this we define the following terms used further on.

Serving eNodeB set: This is the set of eNodeBs currently connected to the UE. Typically the number of eNodeBs in this set would be two, but the disclosure is not limited to this number.

Main serving eNodeB: This is one of the eNodeBs in the Serving eNodeB set that is configured to have some type of control over the other eNodeBs in that set.

Scheduling eNodeB: This is the eNodeB that performs a PDSCH transmission to the UE in a certain sub frame.

It is further given that the network can schedule messages towards the UE from all eNodeBs in the Serving eNodeB set. In a network operation wherein the disclosure is used for enhancing mobility, it is possible that the network designates one of the configured eNodeBs in that set to be the Main serving eNodeB. This would imply that the network would mainly use the PDSCH of this eNodeB to schedule data for the UE. If the network would need to send a mobility associated message (e.g. handover commands) to the UE it can then utilize all eNodeBs in the Serving eNodeB set. The PDSCH message can then be sent in several different ways to the UE depending on the network decision.

In a first embodiment an ePDCCH scheduling message with a corresponding PDSCH message is scheduled from one of the eNodeBs in the Serving eNodeB set. To improve mobility robustness, the ePDCCH scheduling message and the corresponding PDSCH message may be transmitted by another eNodeB in the serving eNodeB set at a later time.

In a second example two separate ePDCCH scheduling messages are sent from two eNodeBs in the Serving eNodeB set which point towards two different PDSCH messages.

In a third example, two separate ePDCCH messages are sent from each eNodeB in the Serving eNodeB set pointing towards the same PDSCH message that is sent so that it combines over the air to the terminal, i.e. it is sent in SFN (Single Frequency Network) fashion. In this case a third CSI-RS resource is configured which is also transmitted from both eNodeBs in SFN mode. The PDSCH transmission can then be QCL with the third CSI-RS and this association can be indicated by the PDSCH to RE mapping and Quasi-co-location state indicator in DCI format 2D in the scheduling messages transmitted from the two eNodeBs respectively.

In a fourth example the same ePDCCH messages are sent from each eNodeB in the Serving eNodeB set and point towards the same PDSCH message. Both the ePDCCH and PDSCH messages are sent so that they combine over the air to the terminal, i.e. they are sent in SFN fashion. Moreover the CSI-RS resource associated with the ePDCCH set is also sent in SFN fashion from both network eNodeBs.

It is noted that in the third and fourth example above we have the same ePDCCH scheduling message and PDSCH message being transmitted from multiple eNodeBs at the same occasion. This needs to be coordinated among the eNodeBs in the Serving eNodeB set. It can for example be done by letting one of the eNodeBs decide that a certain message/ePDCCH needs to be sent to terminal. The deciding eNodeB can prepare this message/ePDCCH and send it to the other serving eNodeBs over the backhaul together with the time the message/ePDCCH should be transmitted, on which resources (PRBs), DMRS configuration as for example the sequence that is used for the DMRs, which scrambling sequence should be used on the message/ePDCCH. The deciding eNodeB could for example be the Main Serving eNodeB for the UE, which may then also act as a serving eNodeB according to the terminal and core network.

It is further noted that in case the UE operates according to the fourth example above, the UE does not need to be configured with two different CSI-RS together with different ePDCCH sets. Instead the UE could be configured with a single ePDCCH set associated with the two Channel State Information Reference Signals, as described above.

Control messages can also be scheduled from the UE on the Physical Uplink Shared Channel, PUSCH. The PUSCH scheduling message is sent on the ePDCCH and can be sent in several different ways to the UE depending on the network decision.

In a first example an ePDCCH scheduling message is scheduled from one of the eNodeBs in the Serving eNodeB set. To improve mobility robustness, the ePDCCH scheduling message and the corresponding PDSCH message may be transmitted by another eNodeB in the serving eNodeB set at a later time.

In a second example, the same ePDCCH messages are sent from each eNodeB in the Serving eNodeB set so that they combine over the air to the terminal, i.e. it is sent in SFN (Single Frequency Network) fashion. In this case a CSI-RS resource is configured which is transmitted from both eNodeBs in SFN mode. The PUSCH transmission can then be QCL with the third CSI-RS. The PUSCH transmitted by the UE can be received by all the eNBs in the serving Set or only a few or only one of them.

Another aspect of the disclosure is how Hybrid automatic repeat request, HARQ feedback is handled for the UE operating with the transparent RRC scheme. HARQ is a combination of high-rate forward error-correcting coding and ARQ error-control. This applies for both UL and DL HARQ handling.

Firstly the HARQ handling for DL transmissions on PDSCH is described and secondly the HARQ handling on UL transmission on PUSCH is described.

HARQ feedback for DL transmission on PDSCH is transmitted on either PUCCH or PUSCH. HARQ feedback is transmitted on PUCCH if either the UE is configured with simultaneous PUCCH/PUSCH or if the UE is not scheduled a PUSCH transmission for the same subframes as the HARQ feedback should be transmitted. Several different ways of handling the HARQ feedback are envisioned. If the scheduling of PDSCH is only performed by one eNodeB the different approaches for this are highlighted in the section below. If the scheduling is performed by multiple eNodeBs simultaneously, the HARQ feedback can mainly be received in the main serving eNodeB.

Now, turning to HARQ feedback for PUCCH transmissions. In a first example it is assumed that the network would like all the HARQ feedback to be transmitted on PUCCH. The reason being that the network does not then need to know if HARQ feedback was actually multiplexed with a PUSCH transmission that happened to occur at the same time as the HARQ feedback was sent. This can be achieved by configuring the UE with simultaneous PUCCH and PUSCH when the UE operates with transparent RRC diversity as per this disclosure. Alternatively it can be achieved by not scheduling any PUSCH transmissions so that it sent at the same time as any possible HARQ feedback for PDSCH transmission. This means that the eNodeBs in the Serving eNodeB set would need to coordinate which eNodeB schedules the UE in which subframe. This coordination is further described in below. Assuming this setup, the main issue to handle is that the UE is transmitting the HARQ feedback with sufficient power to reach the intended network eNodeB. This may not be a problem that needs to be addressed, but if this is a problem two possible ways of handling it are highlighted here.

To try to compensate for potentially insufficient power, the network can configure the largest possible value for P_{O}_{_}_{UE}_{_}_{PUCCH} that is part of P_{O}_{_}_{PUCCH} that is part of the UE PUCCH power control. By this approach the PUCCH can be received at the eNodeB that is serving the UE in DL. Hence, according to one aspect, the method of enabling exchange of control messages further comprises configuring, step S7b of FIG. 5, the transmit power of the physical uplink control channel above a predetermined value.

Another alternative is that the PUCCH is only received by the Main serving eNodeB. According to this aspect, the method of enabling exchange of control messages further comprises receiving, step S7a of FIG. 5, hybrid automatic repeat request feedback of the second eNodeB 30b and forwarding it to the second eNodeB 30b. The HARQ feedback is then received by the Main serving eNodeB and is forwarded to the Scheduling eNodeB. For this to function properly the Main serving eNodeB needs to be aware of the scheduling information from the Scheduling eNodeB to determine the PUCCH resources and how many HARQ feedback bits the eNodeB should try to decode. The Scheduling eNodeB may also try to decode the PUCCH message and if this fails it can await the information from the Main serving eNodeB. The information needed for the Main serving eNodeB to be able to decode the PUCCH message is at least
a) n_{ECCE,q}: the number of the first ECCE (i.e. lowest ECCE index used to construct the ePDCCH) used for transmission of the corresponding DCI assignment in ePDCCH -PRB-set q,
b) Δ_{ARO}: determined from the HARQ-ACK resource offset field in the DCI format of the corresponding ePDCCH as given in Table 10.1.2.1-1 in 3GPP TS 36.213 V11.1.0),
c) N_{PUCCH,q}^{(e1)}: for ePDCCH -PRB-set q configured by the higher layer parameter pucch-ResourceStartOffset-r11 in 3GPP TS 36.213 V11.1.0),
d) N_{RB}^{ECCE,q}: for ePDCCH -PRB-set q given in section 6.8A.1 in 3GPP TS 36.211 V11.1.0),
e) n′: determined from the antenna port used for localized ePDCCH transmission which is described in section 6.8A.5 in 3GPP TS 36.211)

A second alternative is that the HARQ feedback is always sent back multiplexed with a PUSCH transmission. Hence, according to this aspect of the method of enabling exchange of control messages, a physical uplink shared channel, PUSCH, transmission is always scheduled together with a physical downlink shared channel, PDSCH, transmission; wherein the hybrid automatic repeat request feedback from the PDSCH transmission is multiplexed with the PUSCH.

In such a case the Scheduling eNodeB is always scheduling a PUSCH transmission together with PDSCH transmissions so that the corresponding HARQ feedback from the PDSCH transmission is multiplexed with the PUSCH transmission. In such an operation scenario it is possible for the network to turn off the open loop power control of PUSCH by configuring an alpha=0 in the power control equation and then completely rely on the use of closed loop power control. The corresponding closed loop power control then needs to tune correctly to the eNodeB which is receiving the PUSCH transmissions. In practice this means that the UE needs to be scheduled in a few subframes together for the eNodeB to have an opportunity to adjust the UL power control value that is set. The benefit with this approach is that the HARQ feedback would end up in the Scheduling eNodeB with a minimum use of power from the UE perspective.

HARQ feedback for scheduling of a PUSCH transmission is performed by letting the Main serving eNodeB always transmit an ACK on PHICH (unless the scheduling is only performed by the Main serving eNodeB). If a corresponding retransmission is determined to be necessary the scheduling eNodeB can perform such a task by transmitting an UL grant on ePDCCH at the same time occasion as the PHICH is transmitted or at a later point in time by addressing the already used HARQ process.

Scheduling between the different eNodeBs can be coordinated in different ways. The main method for coordination is that the main serving eNodeB determines when each eNodeB can schedule a message towards the UE. The scheduling can also be combined so that multiple eNodeBs schedule the same message. For example, this coordination can be based on measurement reports from the UE, which indicate that the UE has detected a stronger cell than the serving cell indicating the need for a handover to another eNodeB. In such a case the main serving eNodeB may indicate that each eNodeB in the Serving eNodeB set should schedule an HO command to the UE. The HO command can be scheduled by any of the different options described above.

Another possibility is that the main serving eNodeB determines a scheduling pattern in time where each eNodeB in the Serving eNodeB set is allowed to schedule the UE is certain subframes. For example that the Main serving eNodeB schedules the UE in 1 to 99 subframes and in every hundred subframe a second serving eNodeB can schedule the UE.

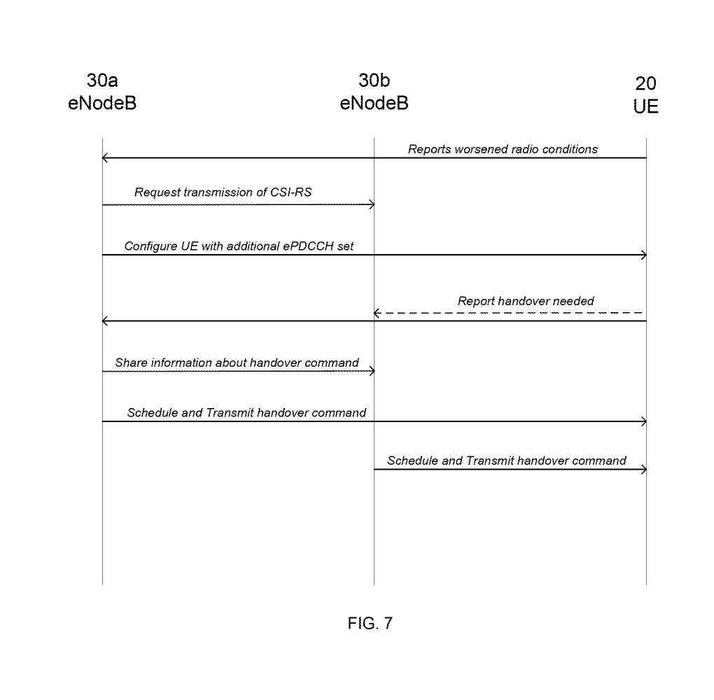

FIG. 7 illustrates the messages exchanged between a main serving eNodeB 30a and a serving eNode B 30b according to one exemplary embodiment of the disclosure. In this example the UE 20 is connected to main serving eNodeB 30a and the main serving eNodeB 30a is already transmitting a first CSI-RS corresponding to step S1a of FIG. 4.

In the first step of FIG. 7, the UE 20 reports 71 worsened radio conditions to the main serving eNodeB 30a. This is e.g. due to the UE 20 moving away from the main serving eNodeB 30a. The main serving eNodeB 30a receives S0 the report and then decides to enable RRC diversity.

Then the main serving eNodeB sends S2 a request to the serving eNodeB 30b, requesting the serving eNodeB to transmit of a CSI-RS and the serving eNodeB receives S11 the message. In response to the request the serving eNodeB transmits S12 the second CSI-RS, not shown.

The main serving eNodeB further sends S3 a message to the UE that configures the UE with an additional ePDCCH set. The additional ePDCCH set corresponds to the CSI-RS of the serving eNodeB.

When channel conditions have decreased further, the UE may then report 72 to the main serving eNodeB, that handover needed. The main serving eNodeB then shares S4 the handover message with the serving eNodeB. In this example, then both the main serving and the serving eNodeB schedules S5, S14 and transmits S6, S15 the handover command. This is possible by scheduling the handover command on an ePDCCH associated with the additional CSI-RS transmitted from the serving eNodeB. By sending the handover command from two eNodeBs, successful reception at the UE is increased.

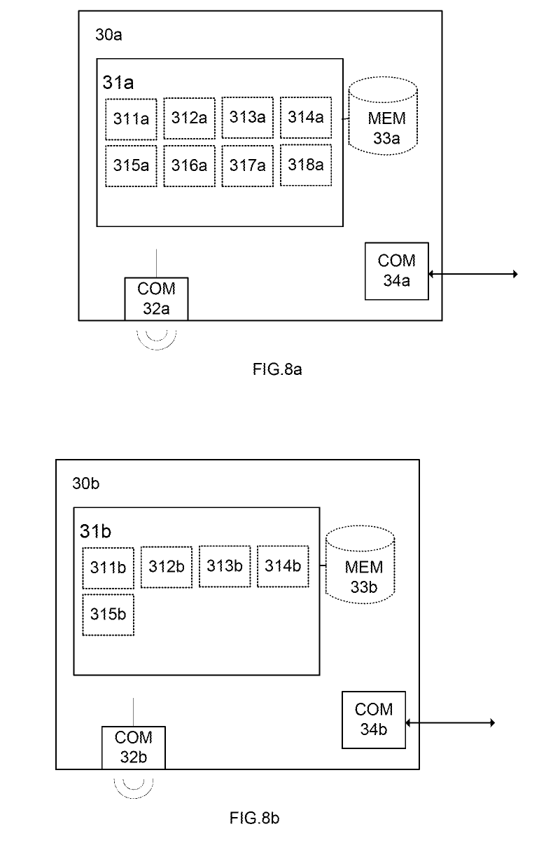

Turning now to FIGS. 8a to 8c schematic diagrams illustrating some modules of an exemplary aspect of a first eNodeB 30a and second eNodeB 30b will be described.

The eNodeBs comprises a processing circuitry 31. According to one aspect the processing circuitry 31 is or comprises a processor. The processor being any suitable Central Processing Unit, CPU, microcontroller, Digital Signal Processor, DSP, etc. capable of executing computer program code. The computer program may be stored in a memory 33. The memory 33 can be any combination of a Read And write Memory, RAM, and a Read Only Memory, ROM. The memory 33 may also comprise persistent storage, which, for example, can be any single one or combination of magnetic memory, optical memory, or solid state memory or even remotely mounted memory. The eNodeBs further comprises a wireless communication unit 32 arranged for wireless communication with user equipments and one communication unit 34 arranged for communication with other eNodeBs in the LTE network. The wireless communication unit 32 and the communication unit 34 are two different communication units or the same.

FIG. 8a discloses a first eNodeB 30a configured for defining a first cell 40a in the Long Term Evolution network, configured for enabling at least one second eNodeB 30b defining a second cell 40b in the Long Term Evolution network, to exchange control messages with a user equipment 20 being connected to the first eNodeB 30a. When the above-mentioned computer program code is run in the processing circuitry 31 of the first eNodeB 30a, it causes the first eNodeB 30a to transmit, using the wireless communication unit 32a, in the first cell 40a, a first Channel State Information Reference Signal, CSI-RS, and send, using the communication unit 34a, to the at least one second eNodeB 30b, a request for the at least one second eNodeB 30b to transmit a second Channel State Information Reference Signal, CSI-RS. The first eNodeB is then caused to send, using the wireless communication unit 32a, to the user equipment 20, a message configuring the user equipment with at least one enhanced physical downlink control channel set; the at least one enhanced physical downlink control channel set being associated with the first and the second Channel State Information Reference Signals.

According to one aspect of the disclosure the processing circuitry 31a of the first eNodeB 30a comprises:
a transmitter module 311a configured to transmit, using the wireless communication unit 32a, in the first cell 40a, a first Channel State Information Reference Signal, CSI-RS,
a first sender module 312a configured to send, using the communication unit 34a, to the at least one second eNodeB 30b, a request for the at least one second eNodeB 30b to transmit a second Channel State Information Reference Signal, CSI-RS, and a
a second sender module 313a configured to send, using the wireless communication unit 32a, to the user equipment 20, a message configuring the user equipment with at least one enhanced physical downlink control channel set; the at least one enhanced physical downlink control channel set being associated with the first and the second Channel State Information Reference Signals.

The first eNodeBs 31a are further configured to implement all the aspects of the disclosure as described in relation to FIG. 5. According to one aspect the processing circuitry 31a is further adapted to receive S0, from a user equipment, a report on worsened radio conditions. According to one aspect the processing circuitry 31a comprises a receiver module 314a adapted to perform this.

According to one aspect the processing circuitry 31a is further adapted to share S4 with the second eNodeB 30b, information about control messages to be exchanged with the user equipment 20. According to one aspect the processing circuitry 31a comprises a sharing module 315a adapted to perform this.

According to one aspect the processing circuitry 31a is further adapted to schedule S5, on the at least one enhanced physical downlink control channel set configured in the user equipment 20, transmissions of control messages to and/or from the user equipment. According to one aspect the processing circuitry 31a comprises a scheduler 316a adapted to perform this.

According to one aspect the processing circuitry 31a is further adapted to transmit, control messages to and/or from the user equipment. According to one aspect the processing circuitry 31a comprises a transmitter module 317a adapted to perform this.

According to one aspect the processing circuitry 31a is further adapted to receive S7a hybrid automatic repeat request feedback of the second eNodeB 30b and forward it to the second eNodeB 30b. According to one aspect the processing circuitry 31a comprises a HARQ forwarder 318a adapted to perform this.

According to one aspect the processing circuitry 31a is further adapted to configure S7b the transmit power of the physical uplink control channel above a predetermined value. According to one aspect the processing circuitry 31a comprises a power configurer 319a adapted to perform this.

The transmitter module 311a, first sender module 312a and second sender module 313a, the receiver module 314a, the sharing module 315a, the scheduler 316a, the transmitter module 317a, the HARQ forwarder 318a and the power configurer 319a are implemented in hardware or in software or in a combination thereof. The modules 311a, 312a, 313a, 314a, 315a, 316a, 317a, 318a are according to one aspect implemented as a computer program stored in a memory 33a which run on the processing circuitry 31a.

FIG. 8b discloses a second eNodeB 30b defining a second cell in the Long Term Evolution network, configured for enabling exchange of control messages with a user equipment 20 being connected to a first eNodeB 30a defining a first cell 40a in the Long Term Evolution network. When the above-mentioned computer program code is run in the processing circuitry 31a of the second eNodeB 30b, it causes the third eNodeB 30b to receive, using the wireless communication unit 32b, from the first eNodeB 30a, a request for the second eNodeB 30b, to transmit a second Channel State Information Reference Signal, CSI-RS, and transmit, using the wireless communication unit 32b, the second CSI-RS. According to one aspect of the disclosure the processing circuitry 31b of the second eNodeB 30b comprises:
a receiver module 311b configured to receive, using the communication unit 34b, from the first eNodeB 30a, a request for the second eNodeB 30b,
an transmitter module 312b configured to transmit a second Channel State Information Reference Signal, CSI-RS, and transmit, using the wireless communication unit 32b, on the second CSI-RS

The second eNodeBs 31b are further configured to implement all the aspects of the disclosure as described in relation to the methods disclosed in connection with FIG. 6. According to one aspect the processing circuitry 31b is further adapted to share S13 with the first eNodeB 30a, information about control messages to be exchanged with the user equipment 20. According to one aspect the processing circuitry 31b comprises a sharing module 313b adapted to perform this.

According to one aspect the processing circuitry 31b is further adapted to schedule S14, on an ePDCCH set associated with the second CSI-RS, transmissions of control messages to and/or from the user equipment 20. According to one aspect the processing circuitry 31b comprises a scheduler 314b adapted to perform this.

According to one aspect the processing circuitry 31b is further adapted to transmit S15, control messages to and/or from the user equipment 20. According to one aspect the processing circuitry 31b comprises a transmitter module 315b adapted to perform this.

The receiver module 311b, the transmitter module 312b, sharing module 313b, the scheduler 314b and the transmitter module 315b are implemented in hardware or in software or in a combination thereof. The modules 311b, 312b, 313b, 314b, 315b are according to one aspect implemented as a computer program stored in a memory 33b which run on the processing circuitry 31a.

Hence, according to a further aspect the disclosure relates to a computer program, comprising computer readable code which, when run on a processing circuitry 31 of an eNodeB in a cellular communication system, causes the eNodeB to perform any of the methods described above.

1-22. (canceled)

23. A method, performed in a first eNodeB, the first eNodeB defining a first cell in a Long Term Evolution network, of enabling at least one second eNodeB, the second eNodeB, defining a second cell in the Long Term Evolution network, to exchange control messages with a user equipment being connected to the first eNodeB, the method comprising:
transmitting in the first cell, a first Channel State Information Reference Signal (CSI-RS);
sending to the at least one second eNodeB, a request for the at least one second eNodeB to transmit a second CSI-RS; and
sending, to the user equipment, a message configuring the user equipment with at least one enhanced physical downlink control channel (ePDCCH) set, the at least one ePDCCH set being associated with the first CSI-RS and the second CSI-RS.

24. The method of claim 23, wherein the message is configuring the user equipment with a first ePDCCH set associated with the first CSI-RS and a second ePDCCH set associated with the second CSI-RS.

25. The method of claim 23, wherein the first CSI-RS and the second CSI-RS have the same configuration and wherein the user equipment is configured with one ePDCCH set associated with the first CSI-RS and the second CSI-RS.

26. The method of claim 23, further comprising:
receiving, from the user equipment, a report on worsened radio conditions.

27. The method of claim 23, further comprising:
sharing, with the second eNodeB, information about control messages to be exchanged with the user equipment.

28. The method of claim 23, further comprising:
scheduling, on the at least one ePDCCH set configured in the user equipment, transmissions of control messages to and/or from the user equipment.

29. The method of claim 28 wherein the step of scheduling control messages comprises scheduling control messages for transmission to and/or from the second eNodeB.

30. The method of claim 28 wherein the step of scheduling control messages comprises scheduling control messages for transmission to and/or from the first eNodeB.

31. The method of claim 23, further comprising:
transmitting control messages to and/or from the user equipment.

32. The method of claim 23, further comprising:
receiving hybrid automatic repeat request feedback of the second eNodeB and forwarding it to the second eNodeB.

33. The method of claim 23, further comprising:
configuring the transmit power of the physical uplink control channel above a predetermined value.

34. The method of claim 23, wherein a physical uplink shared channel (PUSCH) transmission is always scheduled together with a physical downlink shared channel (PDSCH) transmission; wherein the hybrid automatic repeat request feedback from the PDSCH transmission is multiplexed with the PUSCH.

35. The method of claim 23, wherein the method further comprises sharing the user equipment's C-RNTI assigned in the first eNodeB with the second eNodeB.

36. A method, performed in a second eNodeB, defining a second cell, of enabling exchange of control messages with a user equipment being connected to a first eNodeB defining a first cell, the method comprising:
receiving from the first eNodeB, a request for the second eNodeB, to transmit a second Channel State Information Reference Signal (CSI-RS); and
transmitting the second CSI-RS.

37. The method of claim 36, wherein an enhanced physical downlink control channel (ePDCCH) set configured in the user equipment is associated with the CSI-RS that the second eNodeB is requested to transmit.

38. The method of claim 36, further comprising:
sharing with the first eNodeB, information about control messages to be exchanged with the user equipment.

39. The method of claim 36, further comprising:
Scheduling, on an ePDCCH set associated with the second CSI-RS, transmissions of control messages to and/or from the user equipment.

40. The method of claim 36, wherein the step of scheduling transmissions of control messages comprises scheduling simultaneous transmission by the second eNodeB of a control message to be transmitted in the first eNodeB.

41. The method of claim 36, further comprising:
transmitting, control messages to and/or from the user equipment.

42. A first eNode defining a first cell in the Long Term Evolution network, configured for enabling at least one second eNodeB defining a second cell in the Long Term Evolution network, to exchange control messages with a user equipment being connected to the first eNodeB, the first eNodeB comprising:
a wireless communication unit,
a communication unit, and
a processing circuitry configured to:
transmit, using the wireless communication unit, in the first cell, a first Channel State Information Reference Signal (CSI-RS);
send, using the communication unit, to the at least one second eNodeB, a request for the at least one second eNodeB to transmit a second CSI-RS; and
send, using the wireless communication unit, to the user equipment, a message configuring the user equipment with at least one enhanced physical downlink control channel (ePDCCH) set, the at least one ePDCCH set being associated with the first CSI-RS and the second CSI-RS.

43. A second eNode, defining a second cell in the Long Term Evolution network, configured for enabling exchange of control messages with a user equipment being connected to a first eNodeB defining a first cell in the Long Term Evolution network, the second eNodeB comprising:
a wireless communication unit,
a communication unit, and
a processing circuitry configured to:
receive, using the communication unit, from the first eNodeB, a request for the second eNodeB, to transmit a second Channel State Information Reference Signal (CSI-RS); and
transmit, using the wireless communication unit, the second CSI-RS.

44. A non-transitory computer-readable medium comprising, stored thereupon, a computer program comprising computer readable code configured for execution on a processing circuit of a first eNodeB, the first eNodeB defining a first cell in a Long Term Evolution network, and configured to thereby cause the first eNB to:
transmit in the first cell, a first Channel State Information Reference Signal (CSI-RS);
send, to a second eNodeB, a request for the second eNodeB to transmit a second CSI-RS; and
send, to a user equipment, a message configuring the user equipment with at least one enhanced physical downlink control channel (ePDCCH) set, the at least one ePDCCH set being associated with the first CSI-RS and the second CSI-RS.
